(19) United States
(12) Patent Application Publication
(10) Pub. No.: US 2005/0010701 A1
(43) Pub. Date: Jan. 13, 2005

(54) Frequency translation techniques

(75) Inventor: Yaron Elboim, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/611,796

(22) Filed: Jun. 30, 2003

(51) Int. Cl. G06F 13/00

(52) U.S. Cl. 710/52

(57) ABSTRACT

Briefly, a re-timing buffer system that may insert or remove dummy data during frequency translation.

### FIELD

The subject matter disclosed herein generally relates to techniques to modify a frequency of a signal.

### DESCRIPTION OF RELATED ART

Elastic buffers may be used to modify the frequency of a signal. For example, FIG. 1 depicts an example elastic buffer 10 that may translate a first signal D1, which has a frequency F1, to a second signal D2, which has a frequency F2, where F1 is not equal to F2 and D2 substantially includes information provided in D1. The Peripheral Component Interconnect (PCI) express and InfiniBand Architecture (IBA) standards propose the insertion and deletion of dummy data to/from signal D1 during a frequency translation from F1 to F2. For example, under PCI express, a comma (COM) symbol may mark the start of when dummy data should be added or deleted by buffer 10. To provide signal D2 during a frequency translation from F1 to F2, when F1>F2, buffer 10 may delete dummy data from signal D1, whereas when F2>F1, buffer 10 may insert dummy data into the signal D1. Most designs of elastic buffer 10 may remove dummy data from the input signal D1 but do not insert dummy data. In a frequency translation from F1 to F2, where F2>F1, elastic buffer 10 may not provide any data during an underflow state (i.e., data is requested to be output at D2 faster than new data is provided by D1).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a prior art buffer;

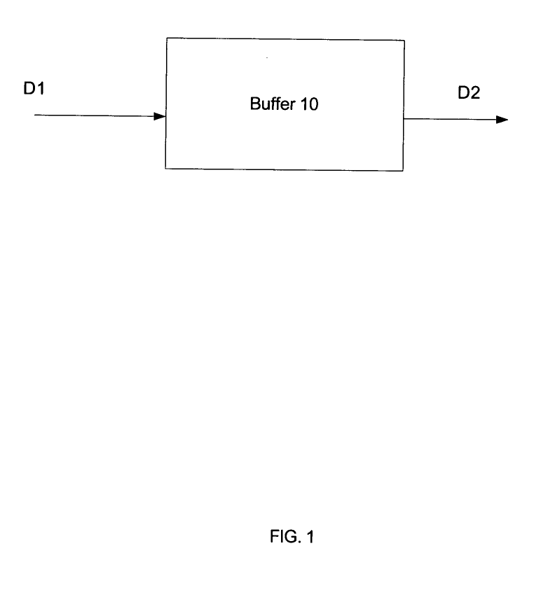

FIG. 2 depicts an example of a system that may use some embodiments of the present invention;

FIG. 3 depicts one embodiment of a buffer system in accordance with an embodiment of the present invention; and

FIG. 4 depicts a suitable process that can be utilized in a buffer, in accordance with an embodiment of the present invention.

Note that use of the same reference numbers in different figures indicates the same or like elements.

### DETAILED DESCRIPTION

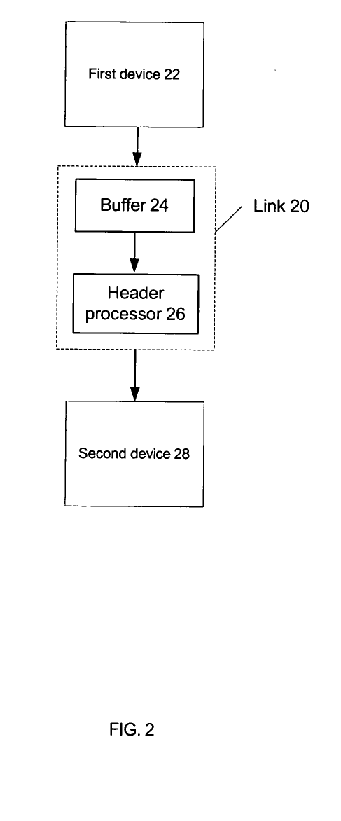

For example, FIG. 2 depicts an example of a system that may use some embodiments of the present invention. Link 20 may provide communications between first device 22 and second device 24 according to for example, PCI express and/or IBA standards. First device 22 and second device 24 may act as interfaces to different computing platforms where each computing platform may include a central processing unit and memory device. Example computing platforms include, but are not limited to: a switch fabric, line card, and/or graphics processor. First device 22 may act as an input/output bridge or memory bridge. Second device 24 may include a translation interface to provide communications between link 20 and a platform that communicates using a standard other than that used by link 20 such as a Gigabit Ethernet compatible interface (described for example in versions of IEEE 802.3 and related standards). Link 20 may include a buffer 24 and header processor 26. Buffer 24 may store bits that are provided by first device 22 for transfer to second device 24. Buffer 24 may use some embodiments of the present invention. Header processor 26 may perform header processing in accordance with PCI express and EBA (e.g., under PCI express, processing of physical, transaction, and data link layers; and under IBA, processing of physical, link, network, and transport layers).

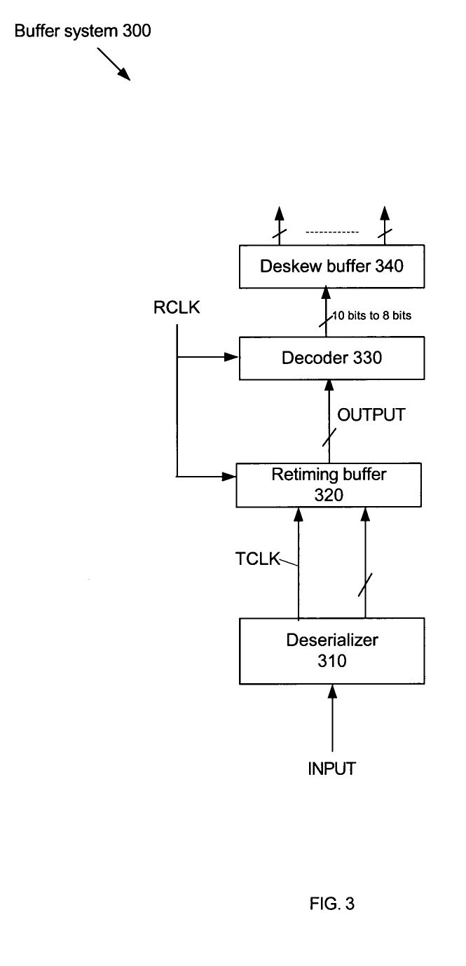

FIG. 3 depicts one embodiment of a buffer system 300 in accordance with an embodiment of the present invention, although other implementations may be used. One implementation of buffer system 300 may include a de-serializer 310, re-timing buffer 320, decoder 330, and de-skew buffers 340. Buffer system 300 may be implemented as any of or a combination of: hardwired logic, software stored by a memory device and executed by a microprocessor, firmware, an application specific integrated circuit (ASIC), and/or a field programmable gate array (FPGA).

De-serializer 310 may convert an input signal (shown as INPUT) from serial to parallel format. De-serializer 310 may attempt to output a symbol in each grouping of parallel bits. A symbol may be multiple bits that are grouped together. For example, to determine the occurrence of a symbol, de-serializer 310 may search for a bit pattern that signifies a boundary between symbols. For example, under PCI express and IBA, a COM symbol may signify a boundary between symbols. In one implementation, de-serializer 310 may examine a serial bit stream to determine whether a boundary bit pattern is present, and based on the presence of the boundary bit pattern, output parallel bits that at least include a symbol. De-serializer 310 may further determine a frequency of signal INPUT and output a clock signal TCLK based on such frequency. For example, clock signal TCLK may have a frequency of the signal INPUT divided by the number of parallel bits output by de-serializer 310.

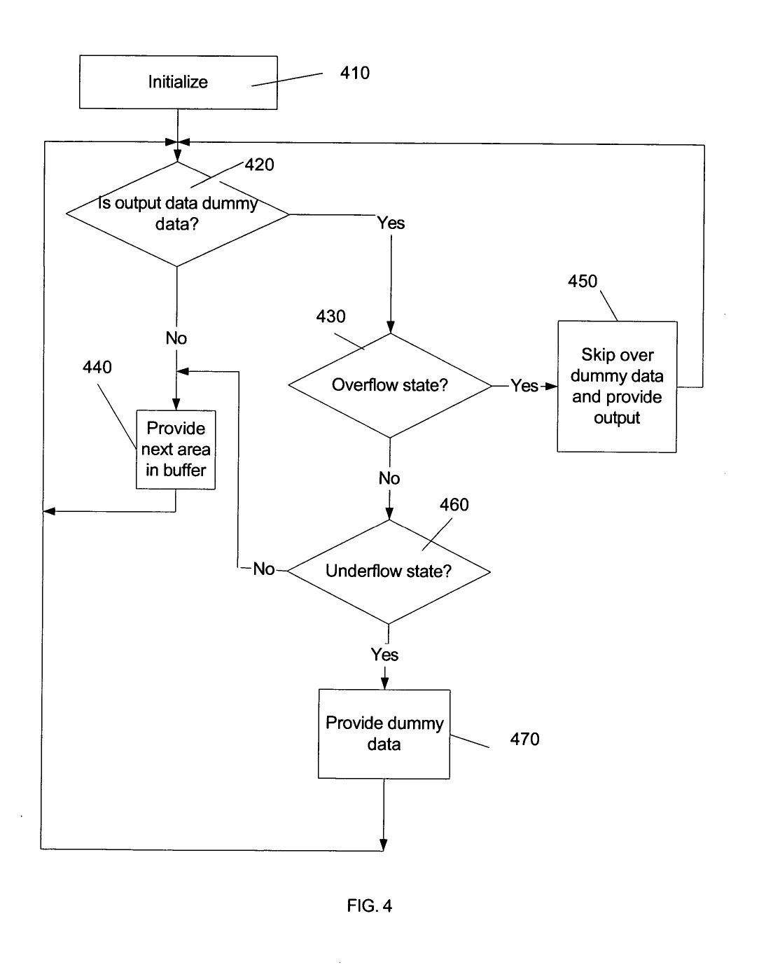

Re-timing buffer 320 may store signal INPUT according to the frequency of clock signal TCLK and output a signal OUTPUT according to a frequency of clock signal RCLK, where TCLK and RCLK have different frequencies. Re-timing buffer 320 may include a storage buffer (not depicted) to store signal INPUT and provide signal OUTPUT based, in part, on bits of signal INPUT. Re-timing buffer 320 may use clock signal TCLK to time storage of signal INPUT and clock signal RCLK to time output of signal OUTPUT.. In one implementation, to provide signal OUTPUT, re-timing buffer 320 may transfer information from signal INPUT and delete or add dummy data substantially in accordance with the process described with respect to FIG. 4. Herein, “data” may include but is not limited to bits whether the bits represent overhead or payload information.

Decoder 330 may convert an A bit parallel stream to a B bit parallel stream, where both A and B are both integers. For example, decoder 330 may perform 8B10B decoding (described by PCI express and IBA specifications) or 64/66B control mapping in accordance with 10-Gbps attachment unit interface (XAUI) (described in versions of IEEE 802.3 and related standards). Decoder 330 may utilize the clock signal RCLK to time its operations.

De-skew buffer 340 may re-order parallel bit streams. For example, in some cases, bit streams may arrive to de-skew buffer 340 out of the intended sequence. De-skew buffer 340 may correct the sequence of parallel bit streams and output multiple parallel streams in correct sequence.

FIG. 4 depicts a possible process to read out data that can be utilized by a storage buffer, in accordance with an embodiment of the present invention. In one implementation, data that is read out of the storage buffer is based on data that is written into the storage buffer. For example, the storage buffer may store data from signal INPUT according to clock signal TCLK and read-out data as signal OUTPUT timed according to the clock signal RCLK.

In action 410, the process initializes. For example, initialization may include initializing a first write location in which to write into the storage device and a first read location from which to read from the storage device. For example, addressing of locations in storage device addressing may be modulo N format, where N is an integer and represents the maximum number of storage locations in the storage device. For example, data may be written into consecutive storage locations and read out from consecutive storage locations. There may be one or more addressable locations between the first write location and first read location.

In action 420, the process may determine whether data immediately read out was dummy data. For example under PCI express, the dummy data may be SKP type. If data immediately read out was dummy data, action 430 may follow action 420. If data immediately read out was not dummy data, action 440 may follow action 420.

In action 430, the process may check for overflow state. For example, action 430 may include determining whether a number of addressable storage locations between subject storage locations in which write and read operations most recently took place are equal to or greater than a specified margin. For example, the margin may be six (6) addressable storage locations or six (6) symbols (where each symbol may be 1 byte). If the buffer is in an overflow state, then action 450 may follow action 430. If the buffer is not in an overflow state, then action 460 may follow action 430.

In action 450, the process may skip over dummy data and provide content of a next storage location. For example, action 450 may include skipping an integer X memory storage locations that store dummy data and providing the content of the next storage location as an output. The content of the next storage location may or may not include dummy data. The integer X may be a minimum number of consecutive storage locations that store dummy data minus one. The integer X can be specified by the storage buffer designer or the relevant governing specification such as PCI express or IBA. In one embodiment, integer X may be two (2).

In action 460, the process may check for an underflow state. For example, action 460 may include determining whether a number of addressable storage locations between subject storage locations in which write and read operations most recently took place are equal to or less than a specified margin. For example, the specified margin may be two (2) addressable storage locations or two (2) symbols (where each symbol may be 1 byte). If the buffer is in an underflow state, then action 470 may follow action 460. If the buffer is not in an underflow state, then action 440 may follow action 460.

In action 470, the process may insert dummy data into the signal that is to be output by the buffer (e.g., signal OUTPUT). For example, action 470 may include reading out the same memory storage location that was previously read and provide such as an output.

In action 440, the process may read from the next storage location and provide such as the output.

Modifications

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. A method comprising:
determining whether data most recently read out includes dummy data;
selectively skipping over dummy data and reading out contents of a next storage location in response to an overflow state; and
selectively reading out the most previously read out data in response to an underflow state.

2. The method of claim 1, further comprising:
selectively reading out data of a next storage location in response to most recently read out data not comprising dummy data.

3. The method of claim 1, further comprising:
selectively reading out data from a next storage location in response to no overflow and no underflow states.

4. The method of claim 1, wherein the selectively skipping over dummy data comprises skipping over at least one storage location.

5. The method of claim 1, wherein the overflow state comprises a number of addressable storage locations between subject storage locations in which write and read operations most recently took place being equal to or greater than a specified margin.

6. The method of claim 1, wherein the underflow state comprises a number of addressable storage locations between subject storage locations in which write and read operations most recently took place being equal to or less than a specified margin.

7. The method of claim 1, further comprising writing data into storage locations according to a first clock rate, wherein each act of reading out is based on a second clock rate and wherein the first and second clock rates differ.

8. The method of claim 1, further comprising:
determining the occurrence of a symbol; and
providing the symbol in parallel as data available for writing into storage locations.

9. An apparatus comprising:
at least one integrated circuit, wherein the integrated circuit is to include the capability, either alone or in combination with other integrated circuits, to:
determine whether data most recently read out includes dummy data;
selectively skip over dummy data and read out contents of a next storage location in response to an overflow state; and
selectively read out the most previously read out data in response to an underflow state.

10. The apparatus of claim 9, further comprising an integrated circuit is to include the capability, either alone or in combination with other integrated circuits, to:
selectively read out data of a next storage location in response to most recently read out data not comprising dummy data.

11. The apparatus of claim 9, further comprising an integrated circuit is to include the capability, either alone or in combination with other integrated circuits, to:
selectively read out data from a next storage location in response to no overflow and no underflow states.

12. The apparatus of claim 9, wherein the integrated circuit is to include the capability, either alone or in combination with other integrated circuits, to selectively skip over dummy data comprises the capability to skip over at least one storage location.

13. The apparatus of claim 9, wherein the overflow state comprises a number of addressable storage locations between subject storage locations in which write and read operations most recently took place being equal to or greater than a specified margin.

14. The apparatus of claim 9, wherein the underflow state comprises a number of addressable storage locations between subject storage locations in which write and read operations most recently took place being equal to or less than a specified margin.

15. The apparatus of claim 9, further comprising an integrated circuit is to include the capability, either alone or in combination with other integrated circuits, to:
write data into storage locations according to a first clock rate, wherein each act of reading out is based on a second clock rate and wherein the first and second clock rates differ.

16. The apparatus of claim 9, further comprising an integrated circuit is to include the capability, either alone or in combination with other integrated circuits, to:
determine the occurrence of a symbol; and
provide the symbol in parallel as data available for writing into storage locations.

17. A system comprising:
a first device to provide an interface with a first computing platform;
a second device to provide an interface with a second computing platform; and
an buffer device comprising at least one integrated circuit, wherein the integrated circuit is to include the capability, either alone or in combination with other integrated circuits, to:
receive data from the first device,
determine whether data most recently read out includes dummy data;
selectively skip over dummy data and read out contents of a next storage location in response to an overflow state;
selectively read out the most previously read out data in response to an underflow state; and
provide the read out data to the second device.

18. The system of claim 17 wherein the buffer device operates in accordance with PCI express.

19. The system of claim 17 wherein the buffer device operates in accordance with the InfiniBand Architecture.

20. The system of claim 17, wherein the first device comprises an input/output device.

21. The system of claim 17, wherein the second device comprises a communications standard translator.
